(19) United States
(12) Patent Application Publication
(10) Pub. No.: US 2015/0067520 A1
(43) Pub. Date: Mar. 5, 2015

(54) SYSTEM FOR GENERATING A PLURALITY OF GRAPHICAL REPORTS FROM A DATA SET

(71) Applicants: Brian Kovacs, Greenwood, IN (US); Eric Marunde, New Glarus, WI (US); Victor Vitvitskiy, Fishers, IN (US)

(72) Inventors: Brian Kovacs, Greenwood, IN (US); Eric Marunde, New Glarus, WI (US); Victor Vitvitskiy, Fishers, IN (US)

(21) Appl. No.: 14/016,782

(22) Filed: Sep. 3, 2013

(51) Int. Cl. G06F 3/0484

(52) U.S. Cl. CPC G06F 3/0484
USPC 715/733

(57) ABSTRACT

A system and method is provided for batch generation of graphic reports from one or more data sets for multiple recipients including, among other features, creation of a report template for graphically presenting information regarding a plurality of subsets of the data set with the ability to specify different graphical presentations of identical data types for different report recipients, and the ability to generate for each report recipient from a library of graphic templates, a report that graphically displays the same type of data differently for different report recipients based on specifying different graphical presentation of identical data types for different report recipients. The system and method also provides for a user to specify the data set(s) and to automatically and periodically send a generated report to each report recipient.

### FIELD OF THE INVENTION

The present disclosure relates to systems for specifying datasets and generating graphical reports for multiple recipients containing information based on the dataset, in which each report may be customized for a particular recipient of the multiple recipients.

### BACKGROUND

The presentation of data via graphic reports is a powerful tool for receiving and understanding data—especially with the amount of data that may be available. In view of this, there are currently a variety of systems for generating graphic reports from various data sources. However, in many of these instances the data that resides within a data source may not be stored in a format for generating graphical reports. Therefore, in order to generate graphical reports the data must be re-formatted (i.e. transposed), merged with any additional data sources to make the data more insightful, apply certain business rules to filter, sort, create new data fields, highlight significant shifts in the data, and then generate the graphical representation. Thus, basically a workflow must be established to define the various data sources and applied data modifier rules to be saved for future generation, eliminating the need for manual intervention for report generation.

Of these prior art systems, it is known to allow batch generation of customized graphic reports for multiple recipients, but the graphical presentation of the graphic reports will be the same for each report recipient. For example, a prior art system can provide a graphic report to multiple recipients consisting of a typical bar chart, for example, or a gauge chart, for example, but not a bar chart to one recipient and a gauge chart to another recipient for the same data.

Thus, in existing systems, all report recipients could be specified to get either the bar chart (one graphical representation) or the gauge chart (another graphical representation), but they do not allow “John Doe” to get the bar chart and “Jane Doe” to get the gauge chart. This is a shortcoming because each person has their own way of comprehending and processing information. Report recipients would better understand information if graphically presented in the way most useful to them.

By way of contrast, a prior art system disclosed in WO 2009/071192 A2 by Buck et al. provides customization of reports but limited to the language of the report. In other words, for each report recipient, the Buck system allows selection of template text of different languages to include in the report. Language, however, is not the same as a graphic element.

Moreover, such prior art systems are not “all inclusive” in that they do not allow for defining a report template since any report or “report template” is hard coded into the prior art systems. Thus, a user of the prior art systems can only filter the data and specify a report recipient. The user cannot specify a particular report template.

It would therefore be desirable to have a system that allows the ability to select, for each report recipient of multiple report recipients, one of a multiple of graphical presentations of the data.

It would also be desirable to have a system that has the ability to present the same data in one graphical format for one recipient, but a different graphical format for a different recipient.

It would be further desirable to have a system that specifies a work flow that automates the generation of graphical reports from data source(s), including, but not limited to, data collection, formatting of the collected data, merging with additional data sources to make the data more insightful, applying certain business rules to filter, order, create new data fields, highlight significant shifts in the data, and generate the graphical representation all within a single software system or platform.

It would be even further desirable to have a single system that generates unique content for each recipient by data set (data that is filtered specifically for each recipient), charts, and chart elements (e.g. each recipient could have a different color bar chart based on their personal preference) based on specified parameters contained in the automation driver data set.

### SUMMARY OF THE INVENTION

The present invention is a system for specifying datasets and generating graphic reports for multiple recipients containing information based on the dataset, in which each graphic report may be customized for the particular recipient.

The present invention provides a single system or platform that defines a persisted work flow (a mechanism to save and reuse) consisting of multiple data sources, merging data from multiple data sources as appropriate, applying business rules to filtering, sorting, creating new data fields, highlighting shifts in the data, and batch charting for a plurality of recipients.

The present system generates in a batch, graphic reports from a data set for multiple recipients, in which different graphical representations of the same type of data is provided for individual report recipients of multiple report recipients.

In a particular embodiment of the invention, the system include means for specifying a plurality of report recipients; means for creating a data set from multiple data sets including specifying references to multiple data sources including Excel, databases, the Internet/Website content, Data files, and others; means for specifying for each report recipient, criteria for selecting a subset of data from the data set to be graphically presented in a report; a library of graphic templates for graphically representing data; means for creating a report template for graphically representing information regarding the plurality of subsets of data including means for specifying different graphical presentation of identical data types for different report recipients; means for generating for each report recipient from the template, a report that graphically displays the same type of data differently for different report recipients based on the means for specifying different graphical presentation of identical data types for different report recipients; and means for storing the report template.

In one form, the means for manipulating or tailoring the data includes, but is not limited to, pivoting rows into columns, transposing columns into rows, row filtering, row sorting, row ranking, filtering distinct rows, removing columns, re-labeling columns, re-ordering columns, grouping columns, concatenating columns, concatenating rows, grouping rows into separate data sets, joining columns from another data set, union rows from other data sets, creating new columns based on an expression (function), calculating shifts in data (statistical testing, gap expressions, etc.) and assigning rule based formatting.

According to an embodiment of the present system, all of the tailored definitions/business rules that are defined for each recipient's preferences, are defined and saved in an automation driver data set. This dataset is used in the automation process for generating the user defined uniqueness of the report over the plurality of report recipients. Automation provides the ability to easily manipulate virtually any property value within the report setup based on conditions of a particular report recipient. This includes properties (or settings) such as which data source a graph gets data from, a filter expression on a data set, the visibility of a graph or page, the recipient email address and text of an email body, and others.

In another embodiment of the invention, the stored template report may include identification of the plurality of report recipients; references to multiple data sources including Excel, databases, the Internet/Web, data files, and others; the library of graphic templates; the templates for graphically presenting information; and the specifications for different graphical presentation of identical data types for different report recipients of the multiple report recipients.

According to another embodiment of the invention, the means for automatically sending via email a generated report to each report recipient with the sending means including means for scheduling the sending periodically, and a server operable to receive a command to generate and send the reports on the periodic basis.

According to still another embodiment of the invention, the means for specifying different graphical presentation of identical data types for different report recipients includes means for selecting the format (color, font style, border style, line style, etc.) of the graphical presentation based on the value of the data being presented via conditional formatting for the purpose of emphasizing aspects of the data meeting certain conditions.

In yet another embodiment of the invention, the means for specifying different graphical representation of identical data types for different report recipients includes means for selecting the shape (attributes) of the graphical presentation based on the value of the data being presented; means for selecting one or more report output formats (e.g. PowerPoint, PDF, Excel, images, etc.) in which the generated report may be generated.

In a still further embodiment of the invention, the means for inserting pages allows for objects to flow to multiple pages based on the dynamic size of the data for each recipient.

In an even further embodiment of the invention, the means for exporting and importing properties for a report, or graphic presentation.

In a further embodiment of the invention, the system further includes a web interface for a report recipient to specify custom report parameters and generate a report based on those parameters.

In a yet further embodiment of the invention, the graphic templates may be vector graphics.

### BRIEF DESCRIPTION OF THE DRAWINGS

The above mentioned and other features of this invention, and the manner of attaining them, will become apparent and the invention itself will be better understood by reference to the following description of an embodiment of the invention taken in conjunction with the accompanying drawings, wherein:

FIGS. 1 through 6 depict screen captures of software utilized in connection with a system and method for generating a plurality of graphical reports from a data set according to the principles of the present invention; and

FIG. 7 is a representation of a platform for implementing the present system and method for generating a plurality of graphical reports from a data set.

Although the drawings represent embodiments of various features and components according to the present invention, the drawings are not necessarily to scale and certain features may be enhanced in order to better illustrate and explain the present invention. The exemplification set out herein thus illustrates embodiments of the invention, and such exemplification is not to be construed as limiting the scope of the invention in any manner.

### DETAILED DESCRIPTION

Those of skill in the art will understand that various details of the invention may be changed without departing from the spirit and scope of the invention. Furthermore, the foregoing description is for illustration only, and not for the purpose of limitation, the invention being defined by the claims.

The figures provide various screen captures of software utilized in connection with a system and method for generating a plurality of graphical reports from a data set according to the principles of the present invention (i.e. the present system and method).

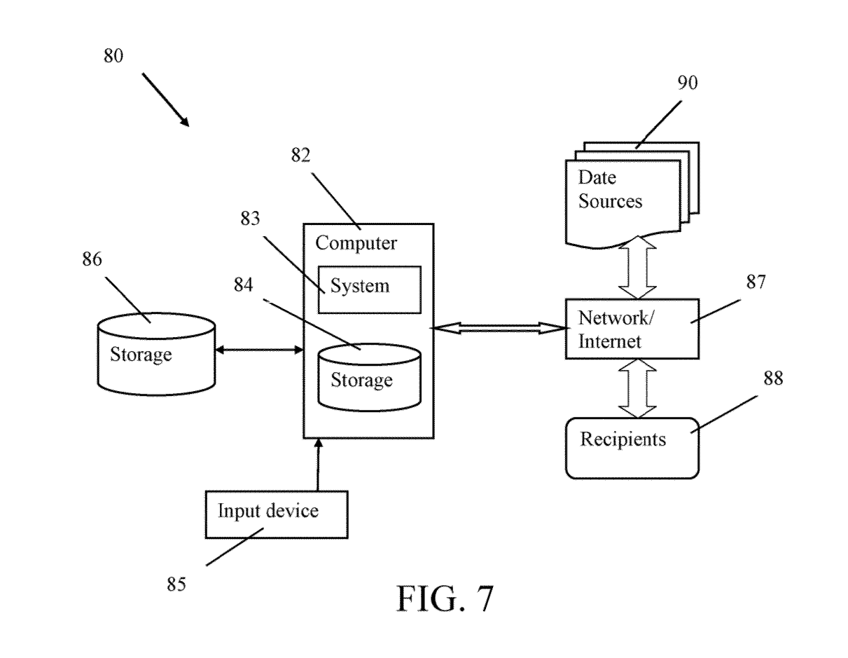

Referring to FIG. 7, there is depicted an exemplary configuration and/or manner 80 of implementing the present system and method for generating a plurality of graphical reports from a data set. It should be appreciated that the configuration 80 is only exemplary and that other configurations are contemplated and within the scope of the present invention. Moreover, it should be appreciated that the present system and method for generating a plurality of graphical reports from a data set may be implemented on a configuration that has fewer components than the configuration 80 shown in FIG. 7.

The configuration 80 includes a computer 82 such as a personal computer, server, tablet, mobile device or the like that can host software/code of the present system and method for generating a plurality of graphical reports from a data set 83 and storage 84. An input device 85 is in communication with the computer 82. A display (not shown) may be in communication with the computer 82 if desired. The computer 82 may be connected to an off-site or remote storage 86 if desired. The storage 86 may contain one or more databases or other information if desired such that the storage 86 may constitute a data source as described herein. Both storages 84, 86 can receive and store graphical reports, without being exhaustive, library of graphic templates, report setups, customized graphical representations of data for report recipients, references to multiple data files where data to be included in the data set, report templates, specifications for different graphical presentation of identical data types for different report recipients, report recipients, data, data subsets, and/or the like. The computer 82 is in communication with a network, the Internet, intranet or the like 87. The network/Internet 87 allows communication with report recipients 88. The network/Internet 87 moreover allows communication with a plurality of data sources 90.

The system thus has one or more databases of report templates, graphic templates, libraries and the like as described herein for execution of same. The present system and method allows the user to customize all aspects of the nature of the report for an individual recipient of multiple recipients. So, for example, if the director of sales on the east coast likes to see a comparison of current year's sales versus a former year's sales in a bar chart, this can be specified for him, and maybe make his bar charts green and blue whereas maybe the preference of the director of sales on the west coast is that he wants that same information in a line chart, and he wants it to be yellow and pink. And that way, the report recipients can receive reports in a way that is most easily understood by them.

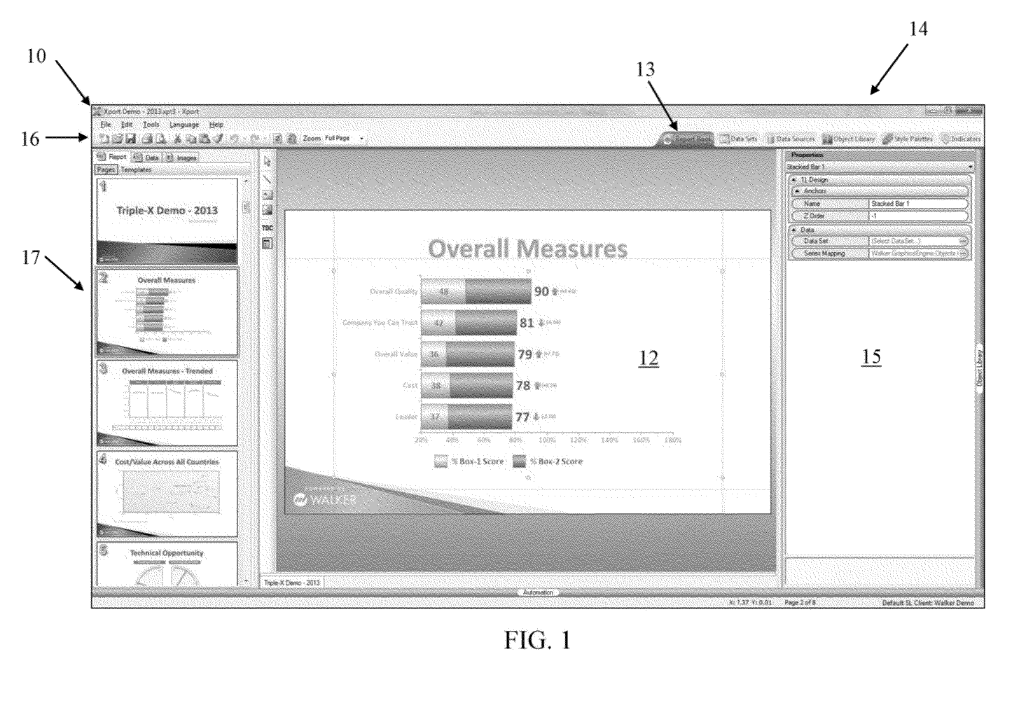

FIG. 1 is a screen capture 10 of the present system illustrating the ability to create a report/report template for graphically representing information regarding data and subsets of data and, particularly to import a file, such as a PowerPoint file, as a background graphical theme, and add data driven charts and other graphics to it via report pages 12. As seen in the screen capture 10, the system 83 provides report generation tabs 14 (Report Book, Data Sets, Data Sources, Style Palettes and Indicators) from which a user may generate graphical reports by clicking on a report generation tab 14 and utilizing its components, options, selections and the like as described herein, and more particularly below. The system 83 includes a typical function area 16.

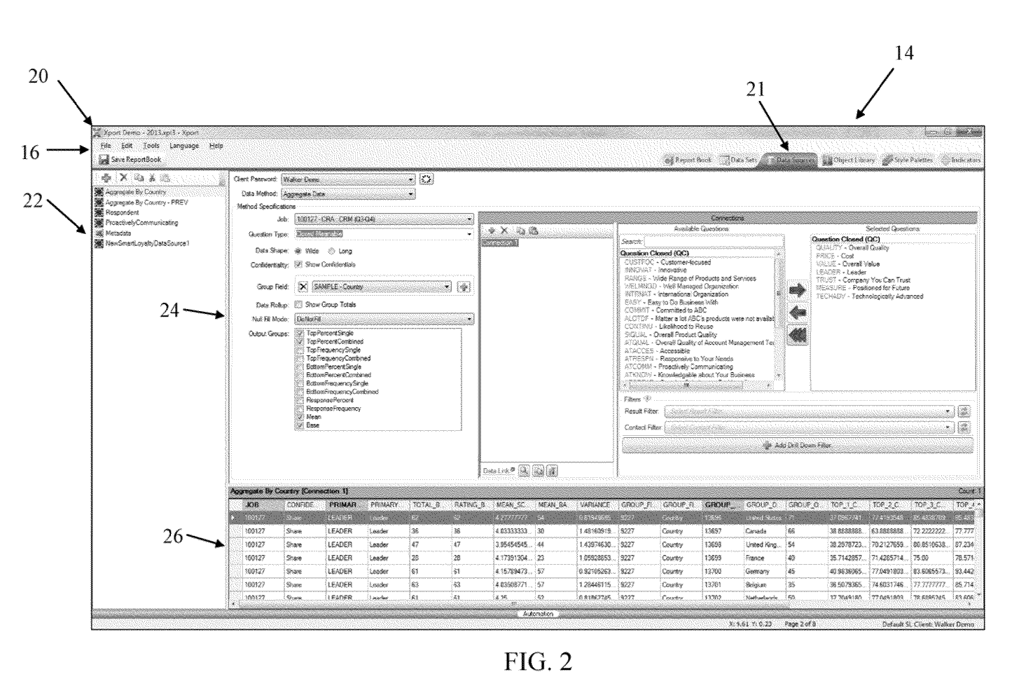

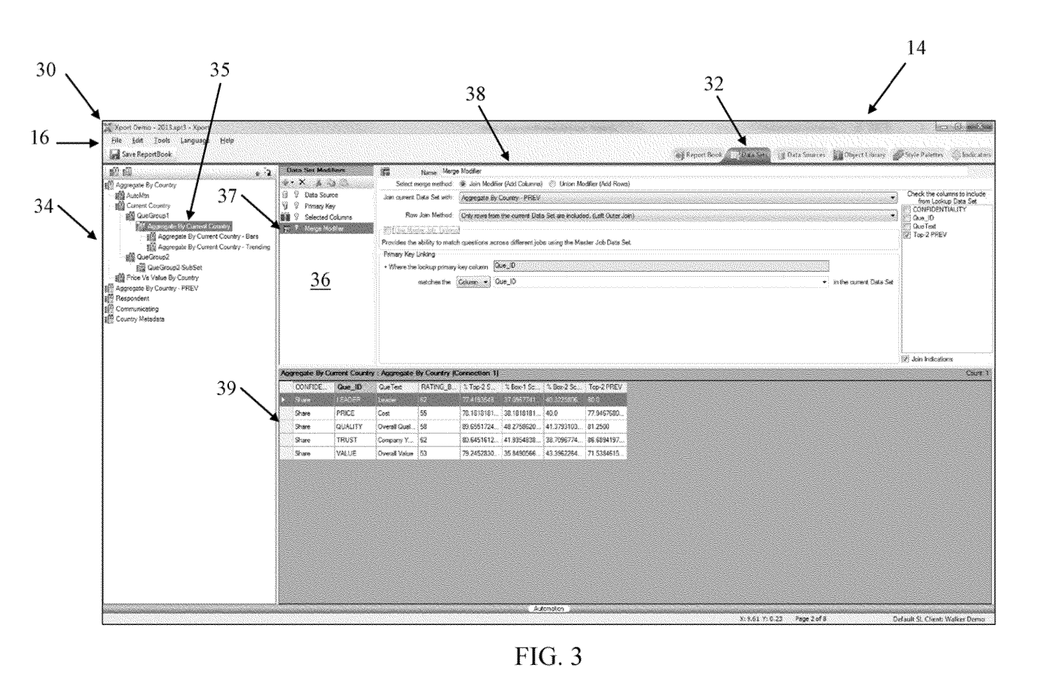

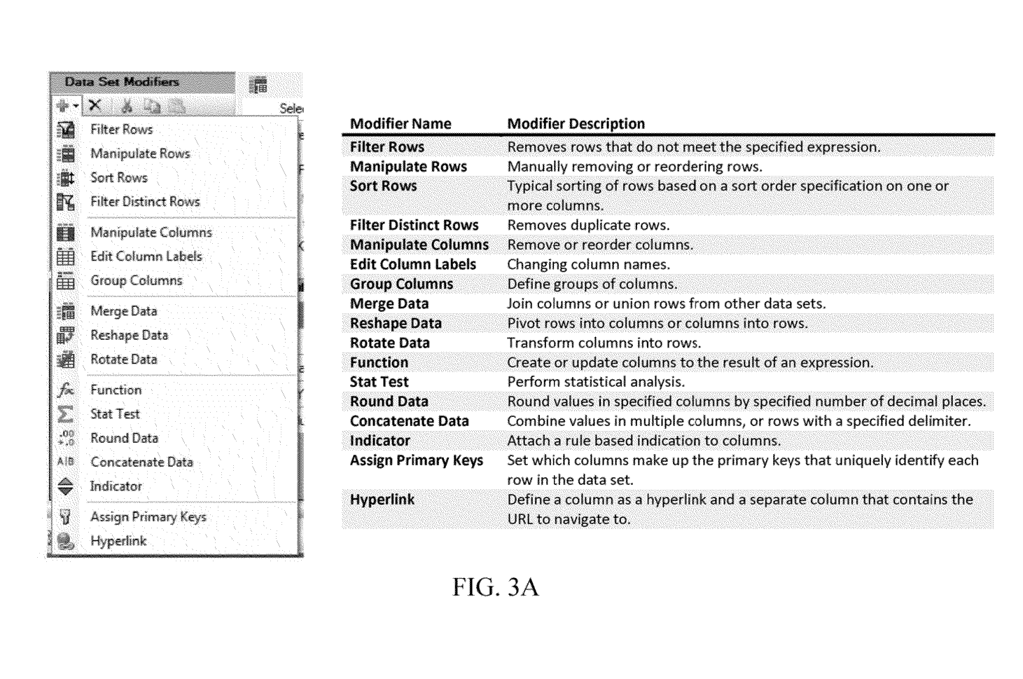

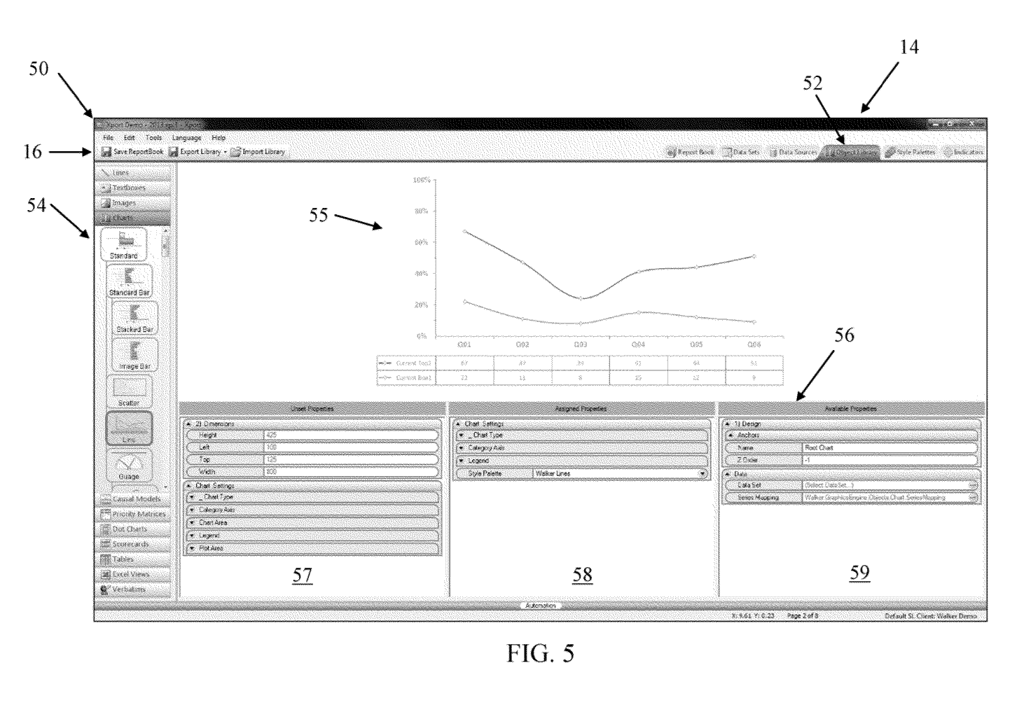

In the screen capture 10, the Report Book tab 13 has been selected and within the Report Book screen the “Triple X Demo-2013” report template has been selected consisting of a plurality of pages of graphs 17. A page 12 of the report template as shown in area 17 can have its properties selected, de-selected, or modified as desired with the shown properties menu/area 15. These graphs have been selected from a plurality of graphic (object) templates (see FIG. 5 and the below description thereof) and populated with data and/or subsets of data from various data sources 90 as specified by the user via the Data Sources tab 21 (see, e.g., FIG. 2) and Data Sets tab 32 (see. e.g., FIG. 3). Once a data set is specified, the graphic (e.g. chart) needs to know what column to put where inside of the graphic so series mapping is invoked. Series mapping provides mapping columns from the data set to the various regions of the graphic. A page 12 of the report template has been selected for viewing and property/object manipulation via Properties area 15. The plurality of pages 17 of the report may graphically present information regarding a plurality of subsets of data including the ability to specify different graphical presentation of identical data types for different report recipients.

FIG. 2 is a screen capture 20 of the present system 83 illustrating the ability to easily pull (obtain) data from multiple data sources including Excel, database, the Internet/Website content, data files, storage 84, 86, and others, creating a data set from multiple data sources, as well as specify references to multiple data files where data to be included in the data set is located. In screen capture 20 the Data Source tab 21 has been selected from the report generation tabs 14 and various selections are provided to provide the functions/features described herein. The Data Source screen provides a data source list area 22 where a user may create, select and/or delete a data source and where the selection of a data source is shown. An options area 24 is provided wherein a user may specify parameters of the selected data source. The available properties of the data source are specific to the type of data source selected in where a plurality of data source types are available including Custom Data Services, ODBC Connections (Oracle), Oracle OBIEE Data Services, Excel, Delimited Text, Website URL, and the like. The content of the selected data/data source is provided in area 26 and assembled per the selected options.

FIG. 3 is a screen capture 30 of the present system 83 illustrating the data workflow engine of the present system that allows one to cut, combine, and manipulate data as needed or desired, such as specifying for each report recipient criteria for selecting a subset of data from the data set to be graphically presented in a report. In the screen capture 30, the Data Sets tab/area 32 has been selected and various selections are provided to provide the functions/features described herein. A hierarchal data set selection area 34 is shown in which a data set may be selected or created to be viewed and modified. A data set modifier stack area 36 is provided for modification of the selected data set 35 by creating, editing, disabling, deleting, or reordering various modifiers (such as, but not limited to those listed in FIG. 3A). A property area 38 is provided for setting properties of the selected data set modifier 37. A table area 39 shows the results of the selected data set as a preview of the data work flow setup. The system 83 allows the creation of as many data sets and sub-data sets as desired where a sub-data set derives its source data from its parent data source and can contain specific manipulations to the data for the sub-data set.

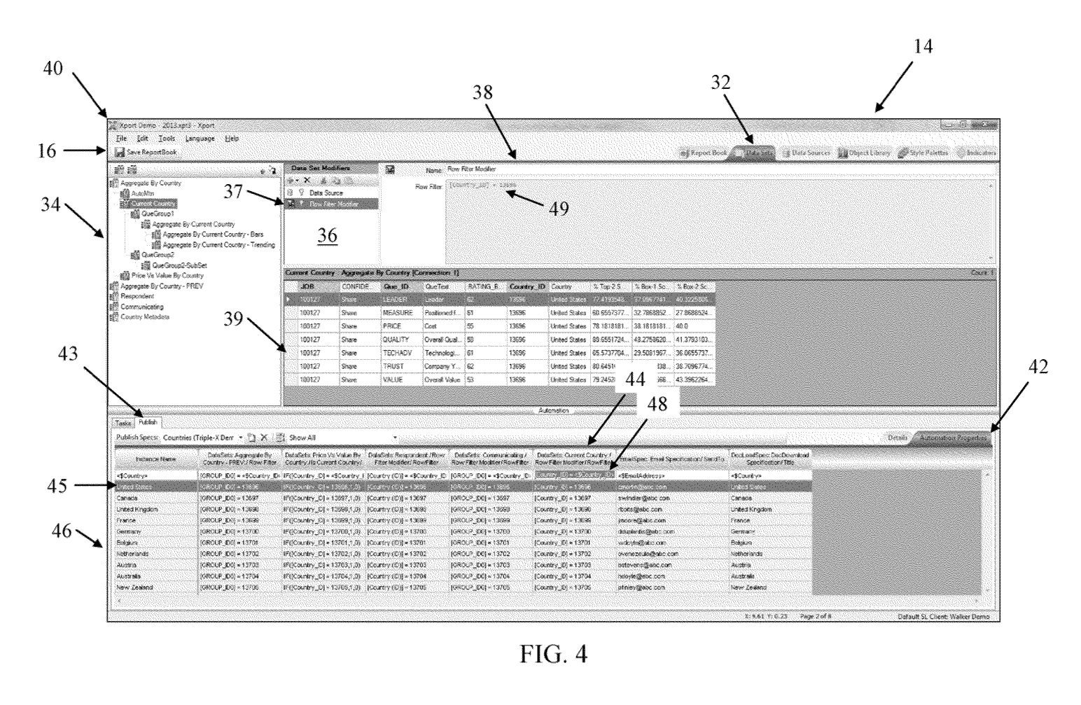

FIG. 4 is a screen capture 40 of the present system 83 illustrating the ability of a user to specify for each report, a data subset through automation filtering via the automation driver such as assigning an ID based on the current report recipient's country. As seen in area 46, a table of report recipients is provided. Typically, the automation driver has an email column that might be a list of people to receive (send to) the graphical report or any specifications that would determine the uniqueness of the final deliverables (e.g. graphical report(s)) at a recipient level (i.e. chart types, colors, dataset filters, and the like).

As shown in the screen capture 40 of the present system 83 the ability to easily define custom data driven automation that iterates over a set of data to provide individual reports across an unlimited number of breaks is illustrated. In the screen capture 40, the automated properties area 42 of the publish panel 43 is shown at the bottom. The automated properties area 42 shows the properties throughout the report setup that have been selected to be controlled by automation. The columns 44 represent each of the properties throughout the report setup that have been selected to be controlled by automation. The rows 46 correspond to each row in the automation driver table. However, the values displayed are the evaluation of the property value expression 48 based on the values in the automation driver table for each corresponding row. For example, column 44 is the automated property entry for filter expression 49. In this case, the automated property value expression 48 is set to ‘[Country_ID]=<$Country_ID>’. This means that for each row 46, the expression will be evaluated by replacing <$Country_ID> with the value of the ‘Country_ID’ column in the automation driver for each corresponding row. This is shown in the table 46 as each row has a different ‘Country_ID’ value. The selected row 45 indicates that the report is currently automated to the ‘United States’ recipient and all of the automated properties will be evaluated to the corresponding values for the ‘United States’ recipient and applied to each property controlled by automation as shown in the filter expression 49.

FIG. 5 is a screen capture 50 of the present system 83 illustrating an advanced Object Library that allows one to style charts and graphics (graphical presentations and templates) however desired, and reuse them throughout the report within the Report Book tab/area 13. If a change is later needed, the graphic template is modified and all of the graphics derived from the modified graphic template in the graphical report will update accordingly. In screen capture 50, the Object Library tab/area 52 allows the user to select, create and delete a graphic template from a plurality of graphic templates shown in area 54. A selected graphic template 55 is shown above an options/properties area 56. There are several overall graphic types in the Object Library like text boxes, charts, tables and others. Each graphic template has a vast plurality of properties to which may be assigned specific settings to get a particular look for the graphic in the option/properties area 56. Individual properties may be transferred between one of three states (Unset, Set, and Available) at any time. The Unset Properties state 57 lists properties that will inherit their value from their parent or by default and cannot be changed. The Set Properties state 58 lists properties that are explicitly set. These properties are assigned a value to be explicitly set for all children and all individual occurrences of this graphic throughout the report. The Available Properties state 59 lists properties that are available to be changed for later children or for individual occurrences of this graphic throughout the report. This allows for setting a default value, but to still allow for variations on individual graphics throughout the report. For example, each chart may have a different top and left coordinate.

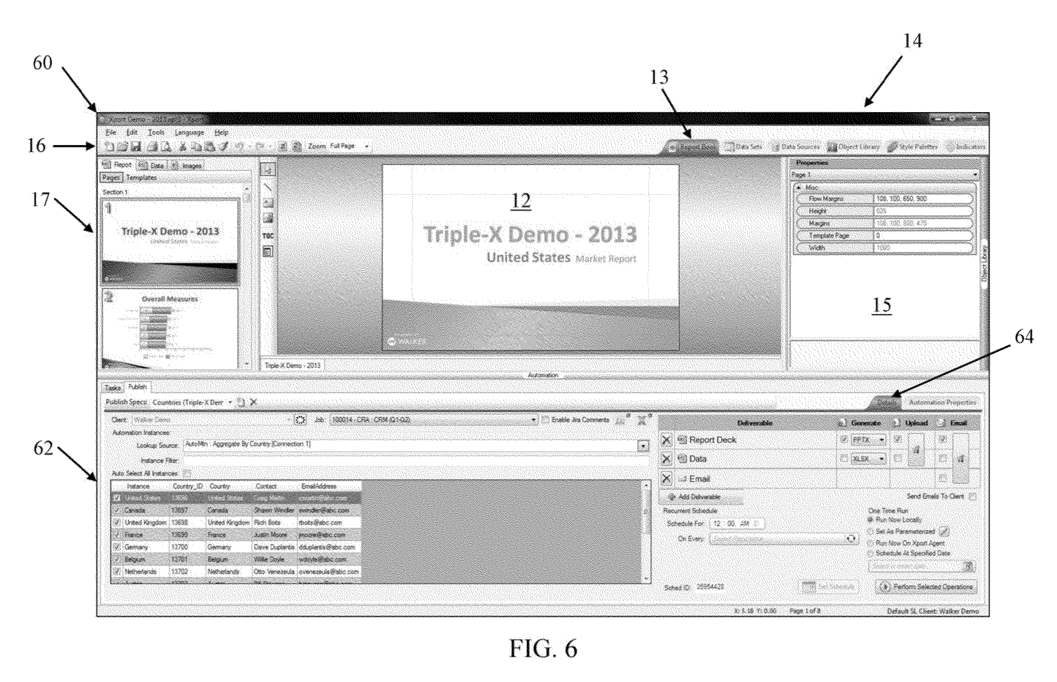

FIG. 6 is a screen capture 60 of the present system 83 illustrating the selection of multiple output deliverable types including, but not limited to, PowerPoint, PDF, Excel, and images with the ability to send individual emails to each automated report recipient within the Report Book tab/area 13. A published specifications area 62 shows the automation recipient and lookup data source (automation driver) for the graphical report. The system 83 provides for each recipient, generation of a report where the graphical template and data workflow is adjusted via automation for each report recipient.

Screen capture 60 of the present system 83 illustrates an overall menu for creating a graphical report in accordance with the present principles. A template for a graphical report titled “United States marketing report” is shown being created. At area 17, pages of the graphical report template are shown. A published specification area 62 shows the automation driver table specifying a plurality of report recipients while a details area/tab 64 provides publication, scheduling, and sending of the graphical reports to the report recipients. All of the various objects or settings of a report are customizable as are depicted in screen capture 60. The automation driver data set contains columns of automation key values to be inserted into the automation property expressions (explained in/with respect to FIG. 4). The columns specify the unique attributes for particular recipients. A common characteristic of the automation driver data set would be to include the email address and the data set filter conditions for each report recipient.

The present system 83 further allows specifying the actions desired to be performed upon depressing a “Perform Selected Operations” button or the like on panel 64, shown in FIG. 6. To include a report recipient, the report recipients are selected in the automation driver table. Report recipients may be designated to receive one or more deliverable types (e.g. “Report Deck”—a Microsoft PowerPoint file, Adobe PDF document or similar; “Data” File—a Microsoft Excel file, a collection of CSV files, or similar; “Images”—a collection of jpeg, bitmap, vector, metafile, or other/similar format that may be imported into PowerPoint or embedded into other systems; “HTML”—an html document containing the report content; or “Email”—a customized email). There are checkboxes next to the “Deliverables” that allow the user to specify what actions are performed when the “Perform Selected Operations” button is depressed. The batch reports can be generated and delivered immediately, or scheduled to be delivered at a later date, or periodically.

The system further allows generated reports to be automatically uploaded to a predefined file location such as storage 86 (which may also be/represent a server). This may be accomplished by checking a box next to the deliverable in the “Upload” column. If this checkbox is selected, a separate system may be accessed by a report recipient, so they can log onto a website and download the report(s).

In most instances, the generated report will be emailed to the multiple report recipients. If this is desired, the checkbox in the Email column next to the deliverable should be checked. The details of the email (To, CC, BCC, Subject and Body portions thereof) can be controlled with automation so that each recipient receives an email custom tailored to them.

As discerned from the various screen captures shown and described herein, the system 83 further includes the ability to select object properties such as color of the data within/relative to a graph. In order to provide further customization of a graphical presentation, the system 83 provides for the selection of shape of the graphical presentation based on the value of the data being presented, and the selection of one or more report formats in which the generated report may be generated. The system 83 may also allow a created report template to import report settings from a PowerPoint-formatted file. The system 83 further may allow for exporting and importing properties for a report or graphic presentation. Additionally, the system 83 further may include a web/Internet interface for a report recipient to specify custom report parameters and generate a report based on those parameters. The web/Internet interface provides a set of web/Internet services for report integration into other platforms.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. A system for generating in a batch, graphic reports from a data set for multiple recipients, comprising:
means for specifying a plurality of report recipients;
means for creating a data set from multiple data sources, the means for creating a data set from multiple data sources including:
specifying references to multiple data sources where data to be included in the data set is located;
means for specifying for each report recipient, criteria for selecting a subset of data from the data set to be graphically presented in a report;
a library of graphic templates for graphically representing data;
means for creating a report template for graphically presenting information regarding the plurality of subsets, the means for creating a report template for graphically presenting information regarding the plurality of subsets including:
means for specifying different graphical presentation of identical data types for different report recipients;
means for generating for each report recipient from the template, a report that graphically displays the same type of data differently for different report recipients based on the means for specifying different graphical presentation of identical data types for different report recipients; and
means for storing the report template, wherein the stored report template includes:
the references to multiple data sources where data to be included in the data set;
the collection of data sets and data manipulation rules that define data workflow;
identification of a data set that contains the list of report recipients and their unique attributes for generating specific reports for each recipient;
the library of graphic templates;
the template for graphically presenting information in a report layout; and
the specifications for different graphical presentation of identical data types for different report recipients.

2. The system of claim 1, further comprising:
means for automatically sending a generated report to each report recipient; and
said sending means including:
means for scheduling the sending of reports periodically; and
a server operable to receive a command to generate and send the reports on the periodic basis.

3. The system of claim 1, wherein the means for specifying different graphical presentation of identical data types for different report recipients further includes:
means for selecting the properties of the graphical presentation based on the recipient's attributes, the properties including graphic parameters, page parameters, data parameters, email parameters, and report upload settings.

4. The system of claim 3, wherein:
the graphic parameters include text, chart type, visibility, titles, color, font, and size;
the page parameters include theme and page visibility;
the data parameters include filtering, data source settings, expressions, and data modifier settings;
the email parameters including To, CC, BCC, Subject, and Body; and
the report upload parameters include destinations and naming.

5. The system of claim 1, further including:
means for selecting one or more report formats in which the generated report may be generated.

6. The system of claim 1, wherein the means for creating a report template further includes:
means for using a PowerPoint-formatted file as the report theme.

7. The system of claim 1, further comprising:
means for exporting and importing settings for a report or graphic presentation.

8. The system of claim 1, further comprising:
a web interface for an external system to specify report parameters and generate a report based on those parameters.

9. The system of claim 1, further comprising:
an interactive website displaying means for a report recipient to specify custom report parameters and generate a report based on those parameters.

10. The system of claim 1, wherein the graphic templates may be vector graphics.

11. A method for generating in a batch, graphic reports from a data set for multiple recipients, comprising:
specifying a plurality of report recipients;
creating a data set from multiple data sources, including:
specifying references to multiple data sources where data to be included in the data set is located;
specifying for each report recipient, criteria for selecting a subset of data from the data set to be graphically presented in a report;
defining data manipulation rules for data workflow
identifying a data set that contains the list of report recipients and their unique attributes for generating specific reports for each recipient;
providing a library of graphic templates for graphically representing data in a report layout;
creating a report template for graphically presenting information regarding the plurality of subsets, including:
specifying different graphical presentation of identical data types for different report recipients;
generating for each report recipient from the template, a report that graphically displays the same type of data differently for different report recipients based on the means for specifying different graphical presentation of identical data types for different report recipients; and
storing the report template including:
identification of the of the plurality of report recipients;
the references to multiple data sources where data to be included in the data set;
the library of graphic templates;
the template for graphically presenting information; and
the specifications for different graphical presentation of identical data types for different report recipients

12. The method of claim 11, further comprising:
automatically sending a generated report to each report recipient, including:
scheduling the sending periodically; and
receiving a command by a server to generate and send the reports on the periodic basis.

13. The method of claim 11, wherein specifying different graphical presentation of identical data types for different report recipients further includes:
selecting the properties of the graphical presentation based on the recipients attributes, wherein:
the properties include graphic parameters, page parameters, data parameters, email parameters, and report upload settings.

14. The method of claim 13, wherein:
the graphic parameters include text, chart type, visibility, titles, color, font, and size;
the page parameters include theme and page visibility;
the data parameters include filtering, data source settings, expressions, and data modifier settings;
the email parameters including To, CC, BCC, Subject, and Body; and
the report upload parameters include destinations and naming.

15. The method of claim 11, further including:
selecting one or more report formats in which the generated report may be generated.

16. The method of claim 11, wherein creating a report template further includes:
using a PowerPoint-formatted file as the report theme.

17. The method of claim 11, further comprising:
exporting and importing settings for a report or graphic presentation.

18. The method of claim 11, further comprising:
providing a web interface for an external system to specify custom report parameters and generate a report based on those parameters.

19. The method of claim 11, wherein the graphic templates may be vector graphics.

20. The method of claim 11, further comprising:
providing an interactive website displaying means for a report recipient to specify custom report parameters and generate a report based on those parameters.
